(19) United States
(12) Patent Application Publication
(10) Pub. No.: US 2004/0205805 A1
(43) Pub. Date: Oct. 14, 2004

(54) Disk shield for optical disks designed to protect DVDs and video game disks

(76) Inventor: Steven Peter Lobisser, Millville, MA (US)

Correspondence Address: STEVEN P. LOBISSER, 35 MAUREEN WAY, MILLVILLE, MA, 01529, US

(21) Appl. No.: 10/306,953

(22) Filed: Nov. 29, 2002

(51) Int. Cl. G11B 3/70; G11B 5/84; G11B 7/26

(52) U.S. Cl. 720/719

(57) ABSTRACT

This invention pertains to protection and preservation of optical disks. This includes but is not limited to DVDs music CDs and video game disks. It is designed to be used as a protector of the surface of said disk, which is used for recording and/or playback. It will adhere to and lay flat on the optical disk and be transparent to the playback/recording device. It will serve as a “skin” to the disk to prevent damage rendering the disk useless.

### CROSS REFERENCE TO RELATED APPLICATIONS

None known

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

This invention pertains to the field of Optical Disks. More specifically, Compact Disks (music or data), DVD Disks, and video game disks. It is designed to prevent these types of media from being damaged by scratches, foreign substances, and general abuse rendering the disk unusable.

### BRIEF SUMMARY OF THE INVENTION

The invention is a thin plastic “shield” to temporarily cover the recorded/playback surface of any version of Optical Disk media. This includes, but is not limited to; Compact Disks (data and music), DVD disks, video game disks and any other form of optical disk to come in the future. Presently, there is no product like this that I am aware of. This thin layer will adhere to the recorded surface and allow the disk to be used normally. It will prevent any damage to the disk, which could normally be caused by rough usage, foreign substances or any other form of damage that would otherwise render the disk unusable. If this “shield” were to become damaged itself, it can then be removed and replaced with another, preserving the disk surface and avoiding a re-surface of the disk or disposal thereof.

### BRIEF DESCRIPTION OF THE DRAWING

FIG. 1 shows an aerial view of the shield. The overall diameter will vary with the Optical Disk it is protecting. Also demonstrates the area of adhesive.

FIG. 2 shows a cross-sectional view depicting the thickness of the shield.

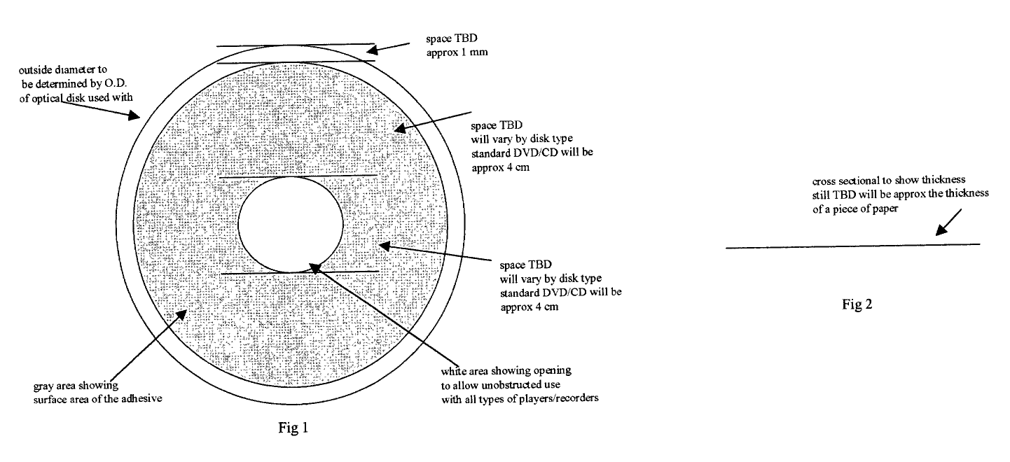

### DETAILED DESCRIPTION OF THE INVENTION

This invention is designed to protect optical disks used to store movies, music, data, video games and such. The optical disk (today known as a CD or DVD) can vary in size and use while the shield will serve the same purpose across all platforms and uses of said disks. This invention will be made of transparent, lightweight, flexible plastic. While the actual weight (or thickness) still needs to be determined by testing, the premise is to have a layer of plastic about the thickness of a piece of paper. This “shield” will be the exact diameter of the disk it is designed to protect. It will accommodate any and all different sizes of disk used today and in the future for movies, music, data, video games, etc. The shield will also have a hole in the center to allow for unobstructed use in all brands of players. The shield will have a light adhesive on one side, an adhesive which will not leave residue once removed, after testing, this adhesive could become “static adhesion” meaning it would statically cling to the optical disk. The other side will be free of any adhesive to allow the disk to be handled as needed. The side with the adhesive will be strong enough to hold its position on the disk and light enough to allow for its easy removal. The side with the adhesive will be placed onto the side of the disk used for playback. The material used for the shield will be static-proof to avoid dust and foreign particles from being attracted to it. The weight of the shield can be designed to different degrees. The thicker the shield, the better the protection. This could vary from 0.5 micrometers to a full millimeter or more depending on the application and cost. Details will be refined once manufacture and testing can be done. The shield will become a second skin on the optical disk, transparent to optical use.

1) What I claim as my invention is the Disk Shield, which is a protective cover to be used on optical disks. This cover can be attached to the disk while the disk is in-use or in its appropriate storage case.

2) A shield according to claim 1, which has a layer of adhesive to adhere to the record or playback side of an optical disk.

3) A shield according to claim 1, which is custom fit to all different types of optical disk media.

4) A shield according to claim 1, which uses static to adhere to the record or playback side of said optical disk.
